(19) United States
(12) Patent Application Publication
(10) Pub. No.: US 2026/0221909 A1
(43) Pub. Date: Jul. 30, 2026

(54) Method of Controlling an Electric Motor and Control System for an Electric Motor

(71) Applicant: Infineon Technologies Austria AG, Villach (AT)

(72) Inventor: Hamid Behjati Najafabadi, Los Angeles, CA (US)

(21) Appl. No.: 19/036,128

(22) Filed: Jan. 24, 2025

(51) Int. Cl. H02P 21/09

(52) U.S. Cl. CPC H02P 21/09; H02P 2207/055; H02P 2209/07

(57) ABSTRACT

A method of controlling an electric motor includes: storing, in a microcontroller, a first weight matrix calculated to transform an arbitrary set of multi-phase variables of any shape to equivalent quadrature-direct (Q-D) reference frame components, such that the Q-D reference frame components appear as dc signals in steady state, the first weight matrix being a function of a reference frame angle in the Q-D reference frame; calculating, by the microcontroller, a second weight matrix from the first weight matrix and a constant matrix, the second weight matrix being a function of the reference frame angle; and commutating winding currents in the electric motor based on the second weight matrix. A corresponding control system for an electric motor is also described.

### BACKGROUND

Conventional quadrature-direct (Q-D) reference frame theory is widely used in Field Oriented Control (FOC) of electric motors where waveforms are sinusoidal. With conventional Q-D reference frame theory, the phase variables (e.g., phase voltages and currents) of a motor are controlled to be balanced sinusoidal waveforms. A set of three (3) phase variables (u, v, w) whose sum is zero (0) can be transformed to a set of two (2) independent variables (q, d) which represent the projection of the ‘uvw’ vector onto a rotating frame. The phase variables (u, v, w) are sinusoidal in steady state for FOC, whereas the Q-D reference frame variables (q, d) are constant in steady state. Accordingly, controlling the Q-D reference frame variables (q, d) instead of the phase variables (u, v, w) decouples the bandwidth of the controller from the frequency of the phase variables (u, v, w).

Other control methods may be used for electric motors and which do not generate pure single-frequency sinusoidal phase variables, e.g., such as block commutation, trapezoidal commutation, harmonic injection, etc. However, conventional Q-D reference frame theory is not used in control methods where the waveforms are non-sinusoidal.

### SUMMARY

According to an embodiment of a method of controlling an electric motor, the method comprises: storing, in a microcontroller, a first weight matrix calculated to transform an arbitrary set of multi-phase variables of any shape to equivalent quadrature-direct (Q-D) reference frame components, such that the Q-D reference frame components appear as dc signals in steady state, wherein the first weight matrix is a function of a reference frame angle in the Q-D reference frame; calculating, by the microcontroller, a second weight matrix from the first weight matrix and a constant matrix, wherein the second weight matrix is a function of the reference frame angle; and commutating winding currents in the electric motor based on the second weight matrix.

According to an embodiment of a control system for an electric motor, the control system comprises: a microcontroller configured to: store a first weight matrix calculated to transform an arbitrary set of multi-phase variables of any shape to equivalent quadrature-direct (Q-D) reference frame components, such that the stationary reference frame components appear as dc in steady state, wherein the first weight matrix is a function of a reference frame angle from the Q-D reference frame; and calculate a second weight matrix from the first weight matrix and a constant matrix, wherein the second weight matrix is a function of the reference frame angle; and generate control signals for commutating winding currents in the electric motor, based on the second weight matrix.

Those skilled in the art will recognize additional features and advantages upon reading the following detailed description, and upon viewing the accompanying drawings.

### BRIEF DESCRIPTION OF THE FIGURES

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 illustrates a block diagram of an embodiment of a control system for an electric motor.

FIGS. 2 through 6 illustrate various waveform shapes for a block commutation embodiment.

FIGS. 7 through 11 illustrate various waveform shapes for a trapezoidal commutation embodiment.

FIGS. 12 through 16 illustrate various waveform shapes for a harmonic injection commutation embodiment.

### DETAILED DESCRIPTION

The embodiments described herein extend Q-D reference frame theory to motor control methods where the waveforms are non-sinusoidal, e.g., such as block commutation, trapezoidal commutation, harmonic injection, etc. Accordingly, motor control methods that do not generate pure sinusoidal waveforms such as block commutation, trapezoidal commutation, harmonic injection, etc. can be seamlessly supported by the same microcontroller. The microcontroller and corresponding control system described herein are simplified and generalized compared to conventional approaches, enabling the microcontroller to share the control code across a variety of motor control methods. This in turn reduces the memory requirement of the microcontroller while simultaneously supporting any desired motor control method (e.g., FOC, block commutation, trapezoidal commutation, harmonic injection, etc.). The embodiments described herein also improve system dynamics by transforming nonlinear steady-state waveforms to constant steady-state values, thereby decoupling the microcontroller bandwidth from the rate of change in the nonlinear waveforms.

Described next, with reference to the figures, are exemplary embodiments of the control method and control system.

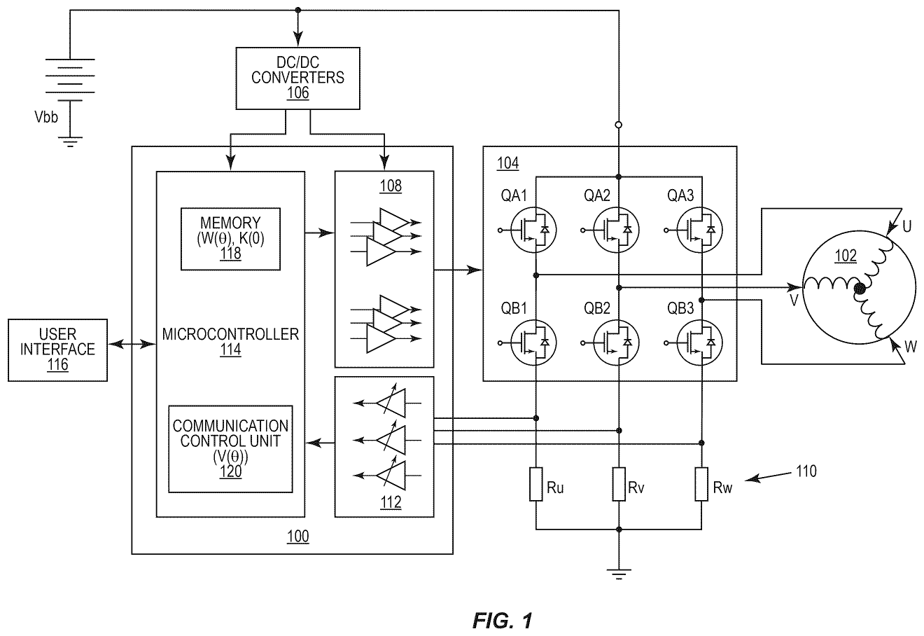

FIG. 1 illustrates a block diagram of an embodiment of a control system 100 for an electric motor 102 such as a PMSM (permanent magnet synchronous motor). The control system 100 generates a command duty cycle ‘ctrl’ for each phase of the electric motor 102. In FIG. 1, the electric motor 102 is shown with three phases: u, v, and w. More generally, the electric motor 102 can have two of more phases. A voltage source inverter (VSI) 104 translates each phase command ‘ctrl’ generated by the control system 100 into a corresponding motor phase voltage which is derived from a voltage source Vbb such as a battery. The control system 100 may be powered by the same voltage source Vbb and at the same voltage level as the VSI 104, or at a different voltage level via one or more DC/DC converters 106.

The VSI 104 is shown in FIG. 1 as a three-phase inverter, since the electric motor 102 has there (3) phases in the illustrated example. Each leg of the three-phase inverter is implemented by a half bridge having a pair of series-connected power transistors QAn, QBn where ‘n’ corresponds to the phase number. The power transistors QAn, QBn are shown as MOSFET devices in FIG. 1 but can be any suitable power transistor type (e.g., IGBT, JFET, etc.).

The control system 100 includes a gate driver 108 for each power transistor QAn, QBn of the VSI 104. Current sense circuitry 110 such as a shunt resistor Rn for each phase of the electric motor 102 enables full-scale ADC (analog-to-digital conversion) at the peak current of the motor 102 plus margin to allow for over current detection. The control system 100 includes current amplification and reconstruction circuitry 112 for generating phase current information from the sensed phase currents. A microcontroller 114 of the control system 100 uses the phase current information and input from a user interface 116 to control the speed and torque of the electric motor 102, using Q-D reference frame theory.

The microcontroller 114 implements Q-D reference frame theory with flexibility to seamlessly support control methods where the waveforms are sinusoidal (e.g., FOC) or non-sinusoidal (e.g., block commutation, trapezoidal commutation, harmonic injection, etc.). That is, the microcontroller 114 shares the control code across a variety of motor control methods. Operation of the microcontroller 114 is described in more detail below in the context of an SMPM (surface mount permanent magnet). However, this description should not be considered limiting. Other electric motor types may be used, e.g., such as an IPM (interior permanent magnet) PMSM (permanent magnet synchronous motor).

The phase voltage equations of an SMPM can be expressed as:

$$\{ \begin{matrix}{v}_{u} = {Ri}_{u} + L \frac{{di}_{u}}{dt} + {e}_{u} \\ {v}_{u} = {Ri}_{v} + L \frac{{di}_{v}}{dt} + {e}_{v} \\ {v}_{w} = {Ri}_{w} + L \frac{{di}_{w}}{dt} + {e}_{w}\end{matrix} \qquad ( 1 )$$

where vₓ, iₓ, and eₓ are the phase voltages, phase currents, and back emfs, respectively. The variables R and L represent the effective phase to neutral resistance and the motor inductance, respectively.

Using Q-D reference frame theory, the three phase variables can be converted to corresponding stationary-frame (αβ) variables using the so-called Clarke transform as follows:

$${\underbrace{[ \begin{matrix}{x}_{α} \\ {x}_{β}\end{matrix} ]}}_{{x}_{α β}} = {\underbrace{\frac{2}{3} [ \begin{matrix}1 & cos ( - α ) & cos ( + α ) \\ 0 & sin ( - α ) & sin ( + α )\end{matrix} ]}}_{K ( 0 )} {\underbrace{[ \begin{matrix}{x}_{u} \\ {x}_{v} \\ {x}_{w}\end{matrix} ]}}_{{x}_{uvw}} \qquad ( 2 )$$

where α=2π/3. The stationary-frame variables x_{αβ} are then converted to the rotating (Q-D) frame variables using the following rotation matrix:

$${\underbrace{[ \begin{matrix}{x}_{q} \\ {x}_{d}\end{matrix} ]}}_{{x}_{qd}} = {\underbrace{[ \begin{matrix}cos ( θ ) & - sin ( θ ) \\ sin ( θ ) & cos ( θ )\end{matrix} ]}}_{R ( θ )} {\underbrace{[ \begin{matrix}{x}_{α} \\ {x}_{β}\end{matrix} ]}}_{{x}_{α β}} \qquad ( 3 )$$

The expressions in (2) and (3) can be combined into:

$${\underbrace{[ \begin{matrix}{x}_{q} \\ {x}_{d}\end{matrix} ]}}_{{x}_{qd}} = {\underbrace{\frac{2}{3} [ \begin{matrix}cos ( θ ) & cos ( θ - α ) & cos ( θ + α ) \\ sin ( θ ) & sin ( θ - α ) & sin ( θ + α )\end{matrix} ]}}_{K ( θ ) = R ( θ ) K ( 0 )} {\underbrace{[ \begin{matrix}{x}_{u} \\ {x}_{v} \\ {x}_{w}\end{matrix} ]}}_{{x}_{uvw}} \qquad ( 4 )$$

where K(θ) denotes the Q-D transformation matrix.

To illustrate how the Q-D transformation decouples the microcontroller bandwidth from the frequency of the phase variables, the phase variables can be presumed to be balanced sinusoidal waveforms with a phase shift γ as follows:

$$[ \begin{matrix}{x}_{u} \\ {x}_{v} \\ {x}_{w}\end{matrix} ] = [ \begin{matrix}cos ( θ + γ ) \\ cos ( θ + γ - α ) \\ cos ( θ + γ + α )\end{matrix} ] [ \begin{matrix}{x}_{q} \\ {x}_{d}\end{matrix} ] = [ \begin{matrix}cos ( γ ) \\ - sin ( γ )\end{matrix} ] \qquad ( 5 )$$

Expression (5) demonstrates that the Q-D transform makes balanced sinusoidal phase variables look constant (dc) in the Q-D reference frame, thus decoupling the microcontroller bandwidth from the frequency of the phase variables.

The rotation matrix R(θ) in (3) has a geometrical meaning, which is the projection of a 2D vector in a stationary frame (x_{αβ}) onto a rotating frame (x_{qd}). A similar geometrical interpretation can be considered for matrix K(θ) in (4).

The method implemented by the control system 100 extends the Q-D reference theory by viewing the matrices R(θ) and K(θ) not as geometrical projections but as algebraic ‘weight’ matrices. This algebraic notion enables an extension of the Q-D reference frame theory to cover arbitrary non-sinusoidal waveforms that do not necessarily have a clear geometrical meaning or represent rotating vectors.

Expressions (3) and (4) can be rewritten as the weight matrices indicated below:

$${\underbrace{[ \begin{matrix}{f}_{q} \\ {f}_{d}\end{matrix} ]}}_{{f}_{qd}} = {\underbrace{[ \begin{matrix}{w}_{11} & {w}_{12} \\ {w}_{21} & {w}_{22}\end{matrix} ]}}_{W ( θ )} {\underbrace{[ \begin{matrix}{f}_{α} \\ {f}_{β}\end{matrix} ]}}_{{f}_{α β}} \qquad ( 6 )$$

$${\underbrace{[ \begin{matrix}{f}_{q} \\ {f}_{d}\end{matrix} ]}}_{{f}_{qd}} = {\underbrace{[ \begin{matrix}{v}_{11} & {v}_{12} & {v}_{13} \\ {v}_{21} & {v}_{22} & {v}_{23}\end{matrix} ]}}_{V ( θ )} {\underbrace{[ \begin{matrix}{f}_{u} \\ {f}_{v} \\ {f}_{w}\end{matrix} ]}}_{{f}_{uvw}} \qquad ( 7 )$$

The microcontroller 114 uses the weight matrix W(θ) in (6) to transform an arbitrary set of multi-phase variables f_{uvw} of any shape to equivalent direct-quadrature (D-Q) reference frame components f_{qd}, such that the D-Q reference frame components f_{qd} appear as dc signals in steady state. As indicated in (6), weight matrix W(θ) is a function of a reference frame angle (θ) in the D-Q reference frame. The microcontroller 114 stores weight matrix W(θ) in memory 118, which can include both volatile (e.g., RAM) and non-volatile (e.g., FLASH) memory.

Weight matrix W(θ) in (6) and weight matrix V(θ) in (7) are solved such that when the waveforms of the stationary frame components f_{αβ} or the multi-phase components f_{uvw} have the desired shapes, their equivalent D-Q reference frame components f_{qd} appear constant (dc). In other words, there is no requirement for f_{αβ} or f_{uvw} to be sinusoidal and instead can have any arbitrary shape. If the multi-phase components f_{uvw} are balanced, i.e., fᵥ(θ)=fᵤ(θ−α), f_{w}(θ)=fᵤ(θ+α), and fᵤ+fᵥ+f_{w}=0, the stationary frame components f_{αβ} can be expressed as:

$${\underbrace{[ \begin{matrix}{f}_{α} \\ {f}_{β}\end{matrix} ]}}_{{f}_{α β}} = {\underbrace{\frac{2}{3} [ \begin{matrix}1 & cos ( - α ) & cos ( + α ) \\ 0 & sin ( - α ) & sin ( + α )\end{matrix} ]}}_{K ( 0 )} {\underbrace{[ \begin{matrix}f ( θ ) \\ f ( θ - α ) \\ f ( θ + α )\end{matrix} ]}}_{{f}_{uvw}} \qquad ( 8 )$$

Combining (6) and (8) results in:

$$W ( θ ) = [ \begin{matrix}{w}_{1} ( θ ) \\ {w}_{2} ( θ )\end{matrix} ] , {w}_{1} ( θ ) = [ \begin{matrix}{w}_{11} & {w}_{12} ] ,\end{matrix} {w}_{2} ( θ ) = [ \begin{matrix}{w}_{21} & {w}_{22} ]\end{matrix} \qquad ( 10 )$$

where:
and γ is an arbitrary phase shift applied to the 3-phase vector f_{uvw} as follows:

$$[ \begin{matrix}{f}_{u} \\ {f}_{v} \\ {f}_{w}\end{matrix} ] = [ \begin{matrix}f ( θ + γ ) \\ f ( θ + γ - α ) \\ f ( θ + γ + α )\end{matrix} ] \qquad ( 11 )$$

The transpose of both sides of (9) yields:

$${[ \begin{matrix}{f}_{q} ( γ ) \\ {f}_{d} ( γ )\end{matrix} ]}^{T} = {[ \begin{matrix}f ( θ + γ ) \\ f ( θ + γ - α ) \\ f ( θ + γ + α )\end{matrix} ]}^{T} {{K ( 0 )}^{T} [ \begin{matrix}{w}_{1} ( θ ) \\ {w}_{2} ( θ )\end{matrix} ]}^{T} \qquad ( 12 )$$

which can be expressed another way as:

$$( 13 )$$

$$[ \begin{matrix}{f}_{q} ( γ ) & {f}_{d} ( γ )\end{matrix} ] = [ \begin{matrix}f ( θ + γ ) & f ( θ + γ - α ) & f ( θ + γ + α ) ] \cdot {K ( 0 )}^{T} \cdot [ \begin{matrix}{w}_{1}^{T} ( θ ) & {w}_{2}^{T} ( θ )\end{matrix} ]\end{matrix}$$

For a given reference frame angle (θ) and a given phase shift (γ), expression (13) describes a system of two equations and four unknowns (w₁₁, w₁₂, w₂₁, w₂₂). This means there are two degrees of freedom in this system.

The two degrees of freedom allow for the design of the weight matrix W(θ) such that for a given set of desired reference phase shifts (γ₁ and γ₂), a given set of desired Q-D frame vectors f_{qd}(γ₁) and f_{qd}(γ₂) can be achieved. Without loss of generality and for illustrative purposes only, the following reference phase shifts (γ₁, γ₂) and reference Q-D vectors (f_{qd}(γ₁), f_{qd}(γ₂)) are chosen for the defined Q-D reference frame:

$${f}_{qd} ( {γ}_{1} ) = [ \begin{matrix}{f}_{q} ( {γ}_{1} = 0 ) \\ {f}_{d} ( {γ}_{1} = 0 )\end{matrix} ] = [ \begin{matrix}1 \\ 0\end{matrix} ] \qquad ( 14 )$$

$${f}_{qd} ( {γ}_{2} ) = [ \begin{matrix}{f}_{q} ( {γ}_{2} = π / 2 ) \\ {f}_{d} ( {γ}_{2} = π / 2 )\end{matrix} ] = [ \begin{matrix}1 \\ - 1\end{matrix} ]$$

The relationships defined in (14) make the extended Q-D reference frame consistent with a conventional sinusoidal reference frame. However, any other choice of reference phase shifts (γ₁, γ₂) and Q-D frame vectors (f_{qd}(γ₁), f_{qd}(γ₂)) may be used and fall within the scope of the embodiments described herein.

Substituting (14) to (13), a complete system of four equations and four unknowns can be constructed for any given reference frame angle (θ) as follows.

$$( 15 )$$

$$[ \begin{matrix}{f}_{q} ( {γ}_{1} ) & {f}_{d} ( {γ}_{1} ) \\ {f}_{q} ( {γ}_{2} ) & {f}_{d} ( {γ}_{2} )\end{matrix} ] = {\underbrace{[ \begin{matrix}f ( θ + {γ}_{1} ) & f ( θ + {γ}_{1} - α ) & f ( θ + {γ}_{1} + α ) \\ f ( θ + {γ}_{2} ) & f ( θ + {γ}_{2} - α ) & f ( θ + {γ}_{2} + α )\end{matrix} ] \cdot {K ( 0 )}^{T}}}_{A ( θ )} \cdot [ \begin{matrix}{w}_{1}^{T} ( θ ) & {w}_{2}^{T} ( θ )\end{matrix} ]$$

where A(θ) is an auxiliary matrix used to simplify the derivations.

From (15), the weight matrix W(θ) can be solved for as follows:

$$\begin{matrix}[ \begin{matrix}{w}_{1}^{T} ( θ ) & {w}_{2}^{T} ( θ )\end{matrix} ] = {A}^{- 1} ( θ ) [ \begin{matrix}{f}_{q} ( {γ}_{1} ) & {f}_{d} ( {γ}_{1} ) \\ {f}_{q} ( {γ}_{2} ) & {f}_{d} ( {γ}_{2} )\end{matrix} ] \\ = {A}^{- 1} ( θ ) [ \begin{matrix}{f}_{qd}^{T} ( {γ}_{1} ) \\ {f}_{qd}^{T} ( {γ}_{2} )\end{matrix} ]\end{matrix} \qquad ( 16 )$$

The transpose of both sides of (16) yields:

$${\underbrace{W ( θ )}}_{equivalent R ( θ )} = [ \begin{matrix}{w}_{1} ( θ ) \\ {w}_{2} ( θ )\end{matrix} ] = {\underbrace{[ \begin{matrix}{f}_{qd} ( {γ}_{1} ) & {f}_{qd} ( {γ}_{2} )\end{matrix} ]}}_{desired values} \cdot {A}^{- T} ( θ ) \qquad ( 17 )$$

which may be expressed as:

$${W ( θ )}_{2 \times 2} = {[ \begin{matrix}{f}_{qd} ( {γ}_{1} ) & {f}_{qd} ( {γ}_{2} )\end{matrix} ]}_{2 \times 2} \cdot ( {K ( 0 )}_{2 \times 3} \cdot [ \begin{matrix}{f}_{uvw} ( θ + {γ}_{1} ) & {{{f}_{uvw} ( θ + {γ}_{2} ) ]}_{3 \times 2} )}^{- 1}\end{matrix} \qquad ( 18 )$$

Expression (18) describes a 2×2 weight matrix W(θ)_{2×2} that can be calculated to transform an arbitrary set of three-phase variables f_{uvw} of any (sinusoidal or non-sinusoidal) shape to the equivalent Q-D frame components f_{qd}, such that the Q-D frame components appear constant (dc) in steady state and not a function of the reference frame angle θ.

Combining (18) with (6) and (7), a 2×3 (second) weight matrix V(θ), which is equivalent to K(θ) in conventional Q-D reference frame theory, can be calculated by a commutation control unit 120 of the microcontroller 114 as follows:

$${\underbrace{{V ( θ )}_{2 \times 3}}}_{equivalent to K ( θ )} = {W ( θ )}_{2 \times 2} {K ( 0 )}_{2 \times 3} \qquad ( 19 )$$

That is, the commutation control unit 120 can calculate the (second) weight matrix V(θ)_{2×3} from the (first) weight matrix W(θ)_{2×2} and a constant matrix K(θ)_{2×3}, such that the weight matrix V(θ)_{2×3} is a function of the reference frame angle (θ). The microcontroller 114 commutates the winding currents in the electric motor 102 based on the weight matrix V(θ)_{2×3}, by providing corresponding gate drive (control) signals ‘ctrl’ to the gate driver circuitry 108.

For the 3-phase variable (u, v, w) case, the first weight matrix W(θ)_{2×2} is calculated from a 2×2 matrix [f_{qd}(γ₁) f_{qd}(γ₂)]_{2×2}, a 2×3 matrix K(θ)_{2×3}, and a 3×2 matrix [f_{uvw}(θ+γ₁) f_{uvw}(θ+γ₂)]_{3×2}, as shown in (18). The first column of the 2×2 matrix [f_{qd}(γ₁) f_{qd}(γ₂)]_{2×2} includes first and second D-Q reference frame values f_{qd}(γ₁) at a first phase shift γ₁ from a defined angle origin. In this example, the defined angle origin is in the same direction as phase u and the reference frame angle (θ) is the phase shift of the arbitrary reference frame. The second column of the 2×2 matrix [f_{qd}(γ₁) f_{qd}(γ₂)]_{2×2} includes the first and second D-Q reference frame values f_{qd}(γ₂) at a second phase shift γ₂ from the defined angle origin.

The first row of the 3×2 matrix [f_{uvw}(θ+γ₁) f_{uvw}(θ+γ₂)]_{3×2} includes values f_{uvw}(θ+γ₁) of the 3-phase variables at the first phase shift γ₁ from the defined angle origin. The second row of the 3×2 matrix [f_{uvw}(θ+γ₁) f_{uvw}(θ+γ₂)]_{3×2} includes values f_{uvw}(θ+γ₂) of the 3-phase variables at the second phase shift γ₂ from the defined angle origin.

In one embodiment, the first phase shift γ₁ is zero (θ) and the second phase shift γ₂ is π/2. Separately or in combination, the 2×3 matrix K(θ)_{2×3} may be a constant matrix. That is, the entries of the 2×3 matrix K(θ)_{2×3} may not depend on the reference frame angle (θ) but instead may be invariable.

Described next are embodiments of the motor control method as applied to non-sinusoidal phase variables used in block commutation, trapezoidal commutation, and harmonic injection. The weight matrix W(θ) used as part of the commutation control can be programmed and stored in the microcontroller memory 118 for block commutation of the winding currents, trapezoidal commutation of the winding currents, or harmonic injection of harmonic currents into windings of the electric motor 102. However, the general framework set out in (18) and (19) is not limited to these three (3) applications. The same framework can be applied to other applications, as well, including other control methods where the waveforms are non-sinusoidal and also FOC where the waveforms are sinusoidal. Broadly, the weight matrices W(θ) and V(θ) are formulated as general weight matrices that can be derived for any desired current and/or voltage shape, f(θ).

Block commutation is a control method that is typically used together with hall sensors. In this control method, only two (2) out of the three (3) phases of the electric motor 102 conduct current at any given time and the current in the third phase is zero (0). In addition, the current flowing through the two (2) active phases is dc (non-sinusoidal).

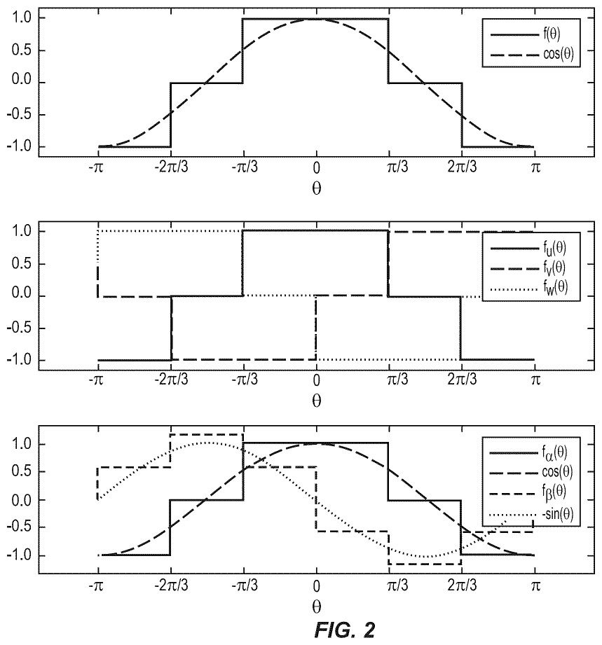

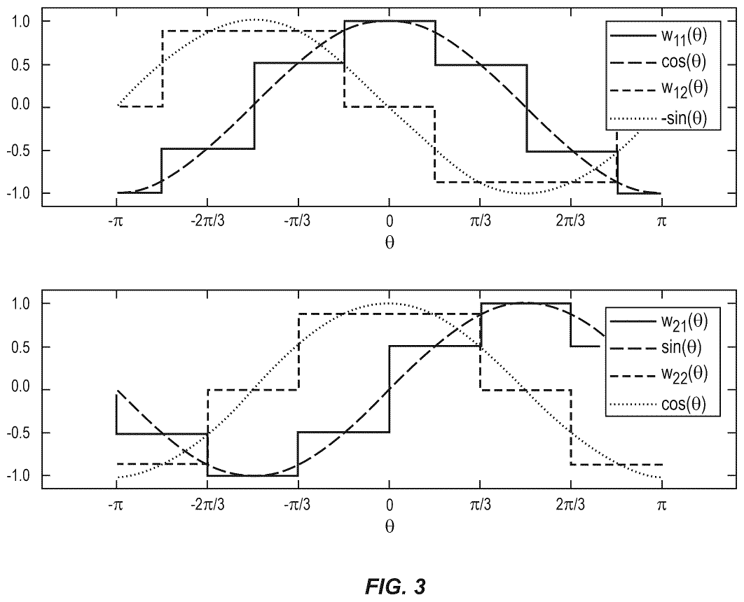

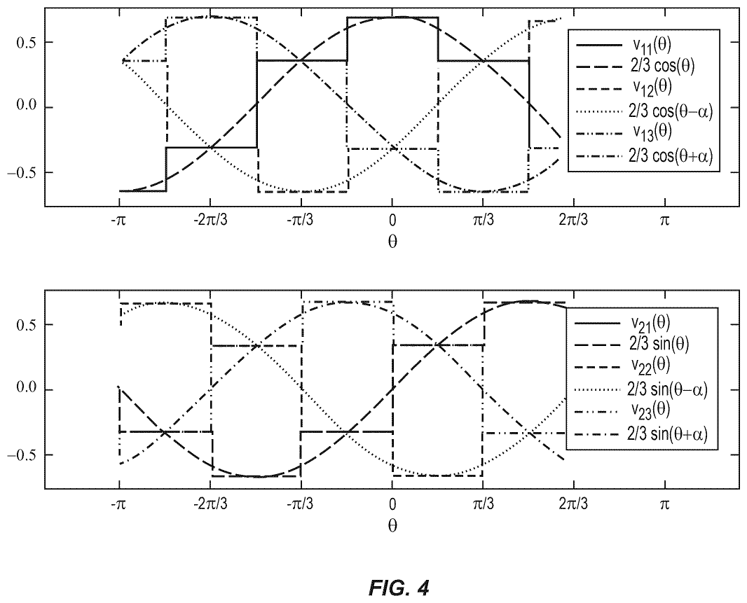

FIG. 2 illustrates the reference waveform shapes in block commutation, including single phase f(θ), three phase f_{uvw}(θ), and the corresponding stationary-frame f_{αβ} currents. The elements of the weight matrix W(θ)_{2×2} can be obtained by applying (18) to the reference three-phase current shapes f_{uvw}(θ) in FIG. 2. The resulting elements w₁₁, w₁₂, w₂₁, w₂₂ of the weight matrix W(θ)_{2×2} are shown in FIG. 3. Similarly, the weight matrix V(θ)_{2×3} can be obtained by applying (19) to the weight matrix W(θ)_{2×2} in FIG. 3. The resulting elements v₁₁, v₁₂, v₁₃, v₂₁, v₂₂, v₂₃ of the weight matrix V(θ)_{2×3} are shown in FIG. 4.

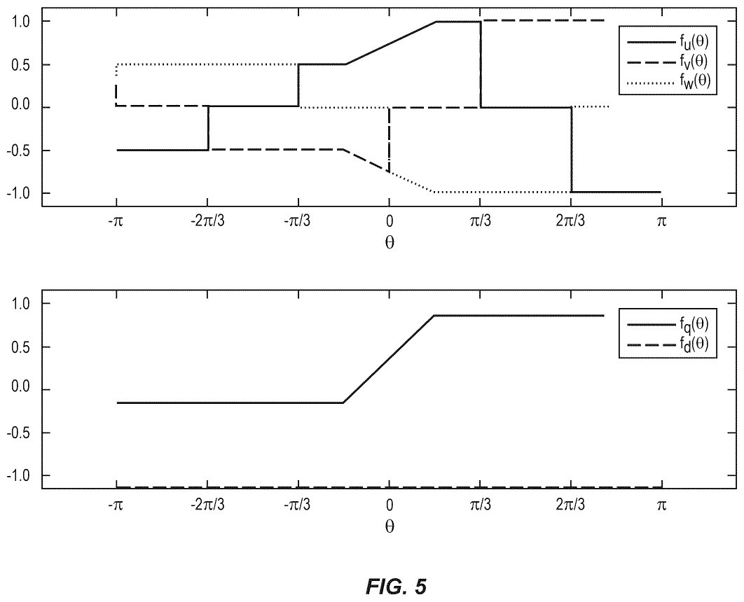

According to the block commutation embodiment, the weight matrix W(θ)_{2×2} is calculated to transform a set of multi-phase variables (u, v, w) of a block shape to D-Q reference frame dc components (q, d) and the elements of the weight matrix V(θ)_{2×3} are block-shaped. FIG. 5 illustrates how the extended Q-D transformation generates dc-like D-Q reference frame components f_{qd} in steady-state, given that the reference three-phase currents f_{uvw} have the desired reference shapes. As seen in FIG. 5, f_{qd} extracts the magnitude of f_{uvw} during transient dynamics.

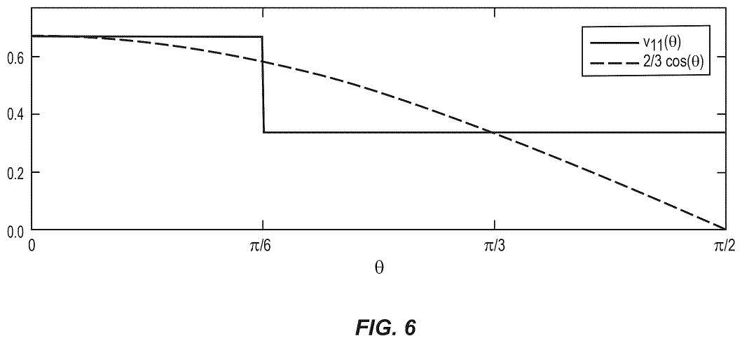

The microcontroller 114 can construct the elements v₁₁, v₁₂, v₁₃, v₂₁, v₂₂, v₂₃ of the weight matrix V(θ)_{2×3} shown in FIG. 4 from a quarter-wave profile stored in the microcontroller memory 118. FIG. 6 illustrates an example of a quarter-wave profile v₁₁ suitable for block commutation. Such characteristics make the method ideal for real-time implementation inside the microcontroller 114, since the method significantly reduces the memory (e.g., FLASH) needed to store the weight matrix V(θ)_{2×3}.

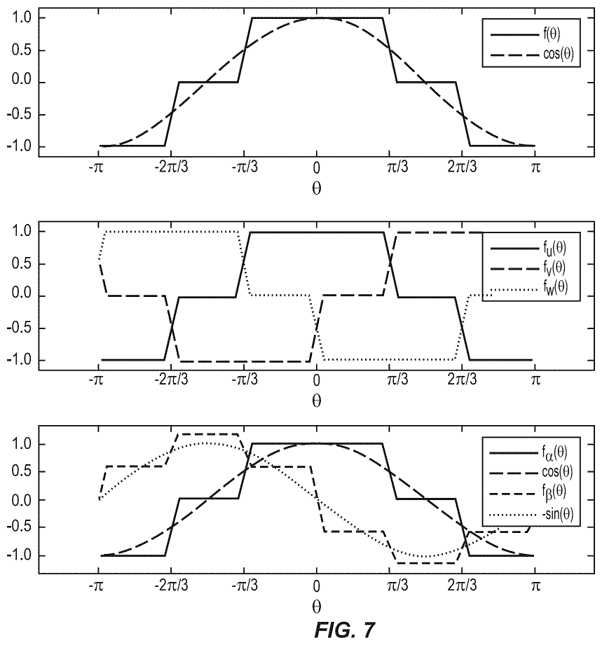

Trapezoidal commutation is an extension of block commutation, by adding controlled ramp-up and ramp-down phases to the winding currents to make the commutation smoother and reduce the commutation torque ripple. FIG. 7 illustrates the reference waveform shapes in trapezoidal commutation, including single phase f(θ), three phase f_{uvw}(θ), and the corresponding stationary-frame f_{αβ} currents.

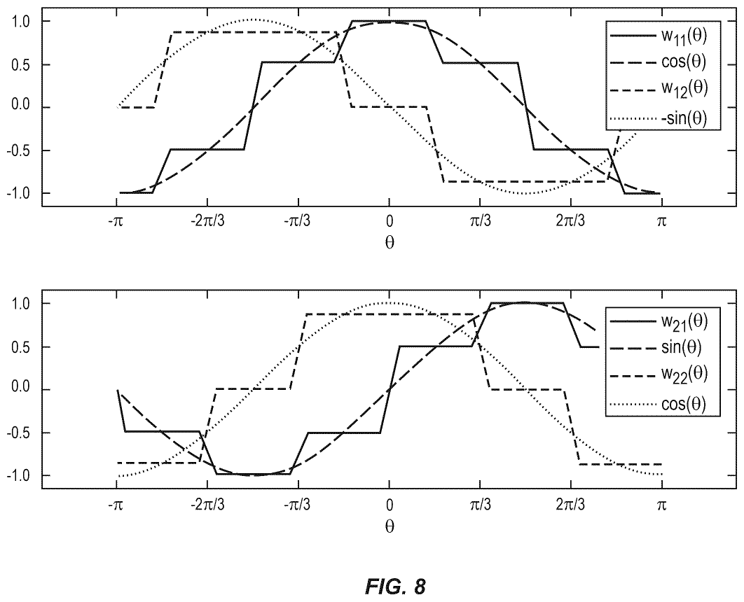

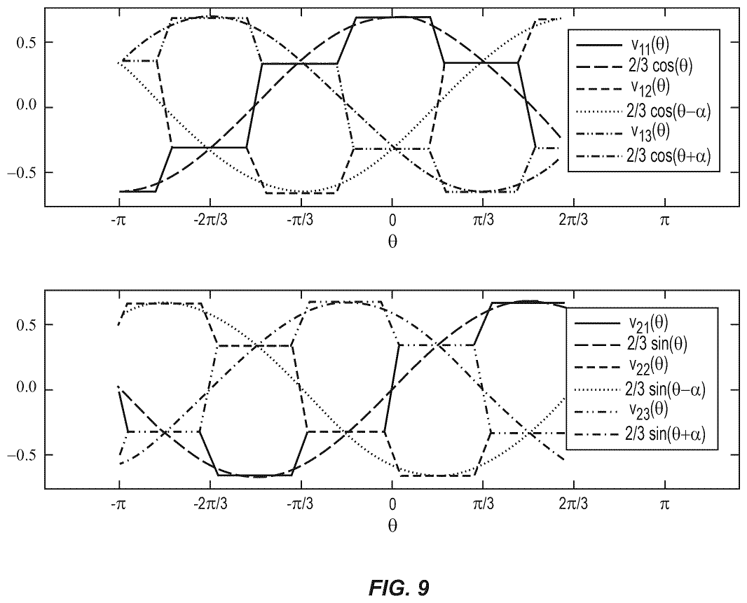

The elements of the weight matrix W(θ)_{2×2} can be obtained by applying (18) to the reference three-phase current shapes f_{uvw}(θ) in FIG. 7. The resulting elements w₁₁, w₁₂, w₂₁, w₂₂ of the weight matrix W(θ)_{2×2} are shown in FIG. 8. Similarly, the weight matrix V(θ)_{2×3} can be obtained by applying (19) to the weight matrix W(θ)_{2×2} in FIG. 8. The resulting elements v₁₁, v₁₂, v₁₃, v₂₁, v₂₂, v₂₃ of the weight matrix V(θ)_{2×3} are shown in FIG. 9.

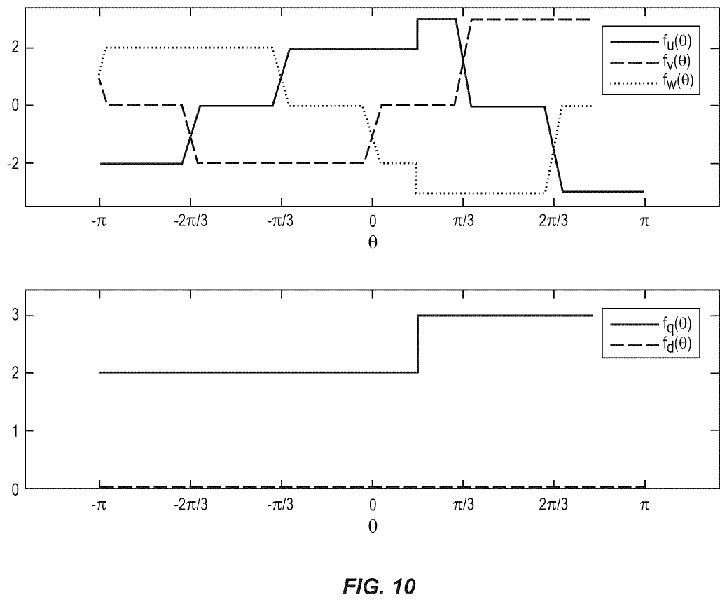

According to the trapezoidal commutation embodiment, the weight matrix W(θ)_{2×2} is calculated to transform a set of multi-phase variables (u, v, w) of a trapezoidal shape to D-Q reference frame dc components (d, q) and the elements v₁₁, v₁₂, v₁₃, v₂₁, v₂₂, v₂₃ of the weight matrix V(θ)_{2×3} are trapezoidal-shaped. FIG. 10 illustrates how the extended Q-D transformation generates dc-like D-Q reference frame components f_{qd} in steady-state, given that the reference three-phase currents f_{uvw} have the desired reference shapes. As seen in FIG. 10, fgd extracts the magnitude of f_{uvw} during transient dynamics.

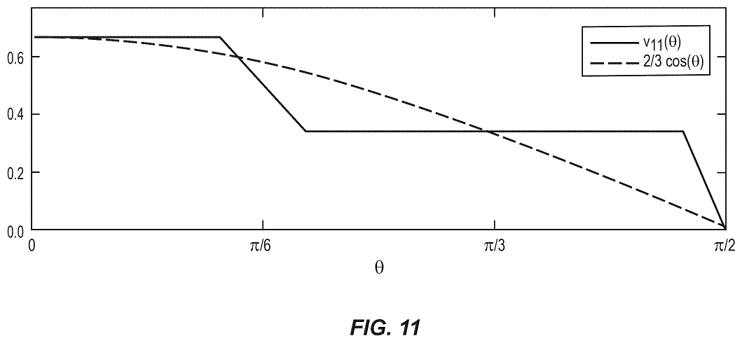

The microcontroller 114 can construct the elements v₁₁, v₁₂, v₁₃, v₂₁, v₂₂, v₂₃ of the weight matrix V(θ)_{2×3} shown in FIG. 9 from a quarter-wave profile stored in the microcontroller memory 118. FIG. 11 illustrates an example of a quarter-wave profile v₁₁ suitable for trapezoidal commutation. Such characteristics make the method ideal for real-time implementation inside the microcontroller 114, since the method significantly reduces the memory (e.g. FLASH) needed to store the weight matrix V(θ)_{2×3}.

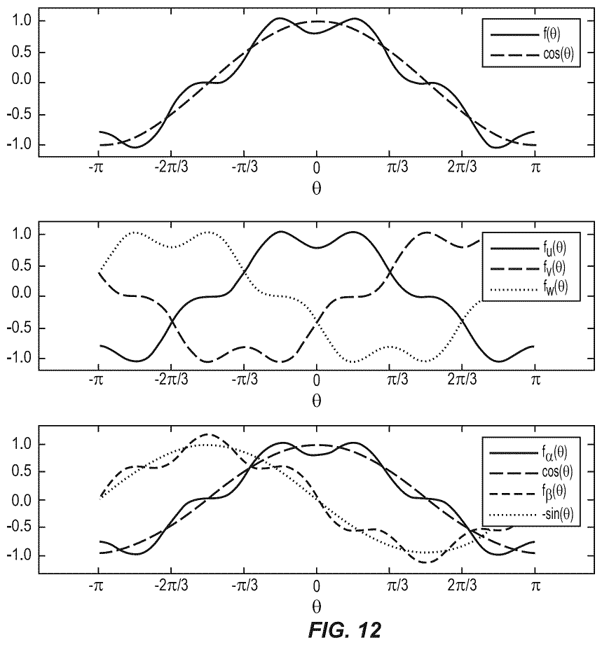

Harmonic injection is typically used in applications where noise and vibration can be reduced by injecting harmonic currents into the motor windings, while the main current component is responsible for producing torque. FIG. 12 illustrates the reference waveform shapes in harmonic injection including single phase f(θ), three phase f_{uvw}(θ), and the corresponding stationary-frame f_{αβ} currents.

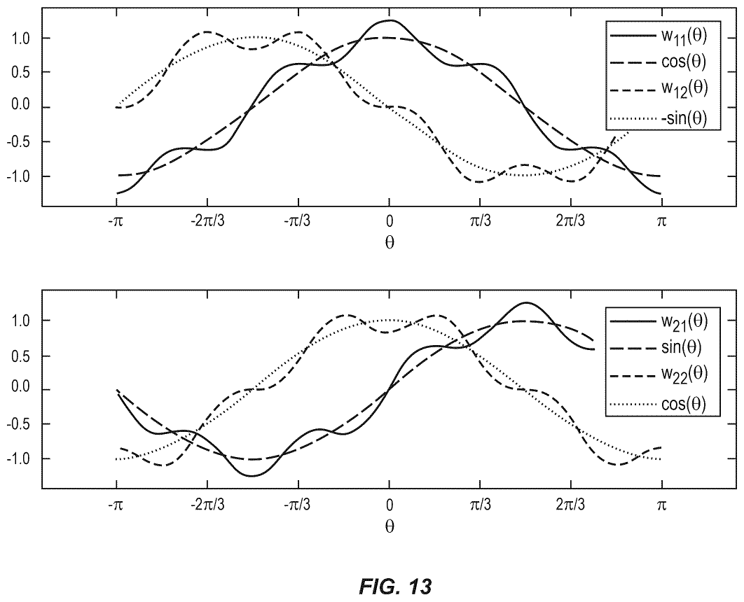

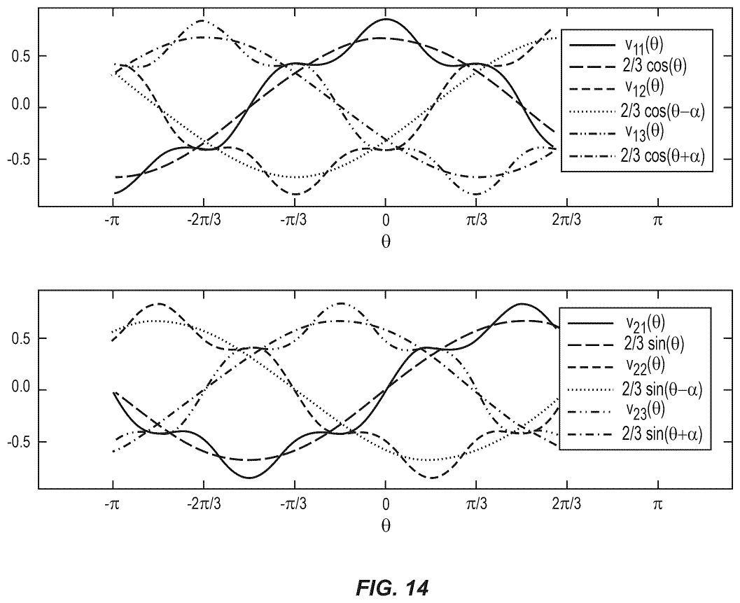

The elements of the weight matrix W(θ)_{2×2} can be obtained by applying (18) to the reference three-phase current shapes f_{uvw}(θ) in FIG. 12. The resulting elements w₁₁, w₁₂, w₂₁, w₂₂ of the weight matrix W(θ)_{2×2} are shown in FIG. 13. Similarly, the weight matrix V(θ)_{2×3} can be obtained by applying (19) to the weight matrix W(θ)_{2×2} in FIG. 13. The resulting elements v₁₁, v₁₂, v₁₃, v₂₁, v₂₂, v₂₃ of the weight matrix V(θ)_{2×3} are shown in FIG. 14.

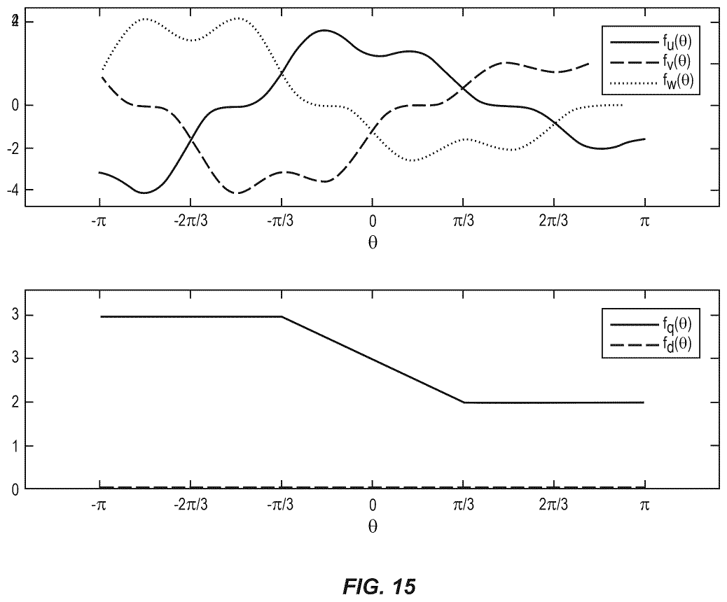

According to the harmonic injection embodiment, the weight matrix W(θ)_{2×2} is calculated to transform a set of multi-phase variables (u, v, w) of a harmonic shape to D-Q reference frame dc components (d, q) and the elements of the weight matrix V(θ)_{2×3} are harmonic-shaped. FIG. 15 illustrates how the extended Q-D transformation generates dc-like D-Q reference frame components f ga in steady-state, given that the reference three-phase currents f_{uvw} have the desired reference shapes. As seen in FIG. 15, f_{qd} extracts the magnitude of f_{uvw} during the transient dynamics.

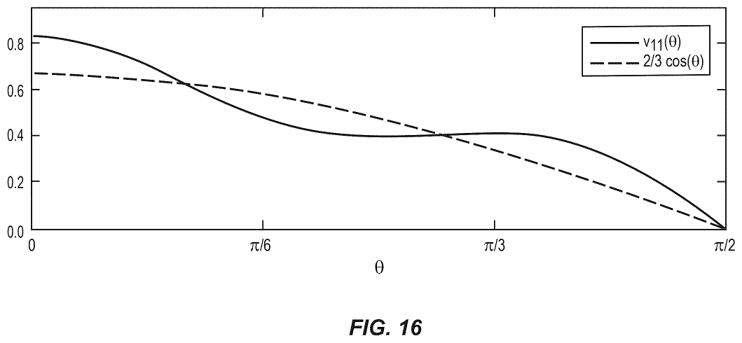

The microcontroller 114 can construct the elements v₁₁, v₁₂, v₁₃, v₂₁, v₂₂, v₂₃ of the weight matrix V(θ)_{2×3} shown in FIG. 14 from a quarter-wave profile stored in the microcontroller memory 118. FIG. 16 illustrates an example of a quarter-wave profile 1211 suitable for commutation that uses harmonic injection. Such characteristics make the method ideal for real-time implementation inside the microcontroller 114, since the method significantly reduces the memory (e.g. FLASH) needed to store the weight matrix V(θ)_{2×3}.

Although the present disclosure is not so limited, the following numbered examples demonstrate one or more aspects of the disclosure.

Example 1. A method of controlling an electric motor, the method comprising: storing, in a microcontroller, a first weight matrix calculated to transform an arbitrary set of multi-phase variables of any shape to equivalent quadrature-direct (Q-D) reference frame components, such that the Q-D reference frame components appear as dc signals in steady state, wherein the first weight matrix is a function of a reference frame angle in the Q-D reference frame; calculating, by the microcontroller, a second weight matrix from the first weight matrix and a constant matrix, wherein the second weight matrix is a function of the reference frame angle; and commutating winding currents in the electric motor based on the second weight matrix.

Example 2. The method of example 1, wherein the multi-phase variables are 3-phase variables, and wherein the first weight matrix is calculated from a 2×2 matrix, a 2×3 matrix, and a 3×2 matrix.

Example 3. The method of example 2, wherein a first column of the 2×2 matrix includes first and second Q-D reference frame values at a first phase shift from a defined angle origin, and wherein a second column of the 2×2 matrix includes the first and second Q-D reference frame values at a second phase shift from the defined angle origin.

Example 4. The method of example 3, wherein the first phase shift is 0 and the second phase shift is π/2.

Example 5. The method of an of examples 2 through 4, wherein the 2×3 matrix is a constant matrix.

Example 6. The method of any of examples 2 through 5, wherein a first row of the 3×2 matrix includes values of the 3-phase variables at a first phase shift from a defined angle origin, and wherein a second row of the 3×2 matrix includes values of the 3-phase variables at a second phase shift from the defined angle origin.

Example 7. The method of any of examples 1 through 6, further comprising: programming the first weight matrix stored in the microcontroller for block commutation of the winding currents, trapezoidal commutation of the winding currents, or harmonic injection of harmonic currents into windings of the electric motor.

Example 8. The method of any of examples 1 through 7, wherein calculating the second weight matrix comprises: calculating each element of the second weight matrix from a quarter wave profile stored in the microcontroller and that defines the shape that the element should follow as a function of the reference frame angle.

Example 9. The method of any of examples 1 through 8, wherein the first weight matrix is calculated to transform a set of multi-phase variables of a block shape to Q-D reference frame dc components, and wherein the elements of the second weight matrix are block-shaped.

Example 10. The method of any of examples 1 through 8, wherein the first weight matrix is calculated to transform a set of multi-phase variables of a trapezoidal shape to Q-D reference frame dc components, and wherein the elements of the second weight matrix are trapezoidal-shaped.

Example 11. The method of any of examples 1 through 8, wherein the first weight matrix is calculated to transform a set of multi-phase variables of a harmonic shape to Q-D reference frame dc components, and wherein the elements of the second weight matrix are harmonic-shaped.

Example 12. A control system for an electric motor, the control system comprising: a microcontroller configured to: store a first weight matrix calculated to transform an arbitrary set of multi-phase variables of any shape to equivalent quadrature-direct (Q-D) reference frame components, such that the stationary reference frame components appear as dc in steady state, wherein the first weight matrix is a function of a reference frame angle from the Q-D reference frame; and calculate a second weight matrix from the first weight matrix and a constant matrix, wherein the second weight matrix is a function of the reference frame angle; and generate control signals for commutating winding currents in the electric motor, based on the second weight matrix.

Example 13. The control system of example 12, wherein the multi-phase variables are 3-phase variables, and wherein the first weight matrix is calculated from a 2×2 matrix, a 2×3 matrix, and a 3×2 matrix.

Example 14. The control system of example 13, wherein a first column of the 2×2 matrix includes first and second Q-D reference frame values at a first phase shift from a defined angle origin, and wherein a second column of the 2×2 matrix includes the first and second Q-D reference frame values at a second phase shift from the defined angle origin.

Example 15. The control system of example 14, wherein the first phase shift is 0 and the second phase shift is π/2.

Example 16. The control system of any of examples 13 through 15, wherein the 2×3 matrix is a constant matrix.

Example 17. The control system of any of examples 13 through 16, wherein a first row of the 3×2 matrix includes values of the 3-phase variables at a first phase shift from a defined angle origin, and wherein a second row of the 3×2 matrix includes values of the 3-phase variables at a second phase shift from the defined angle origin.

Example 18. The control system of any of examples 12 through 17, wherein the microcontroller is configured to calculate each element of the second weight matrix from a quarter wave profile that is stored in the microcontroller and defines the shape that the element should follow as a function of the reference frame angle.

Example 19. The control system of any of examples 12 through 18, wherein the first weight matrix is calculated to transform a set of multi-phase variables of a block shape to Q-D reference frame dc components, and wherein the elements of the second weight matrix are block-shaped.

Example 20. The control system of any of examples 12 through 18, wherein the first weight matrix is calculated to transform a set of multi-phase variables of a trapezoidal shape to Q-D reference frame dc components, and wherein the elements of the second weight matrix are trapezoidal-shaped.

Example 21. The control system of any of examples 12 through 18, wherein the first weight matrix is calculated to transform a set of multi-phase variables of a harmonic shape to Q-D reference frame dc components, and wherein the elements of the second weight matrix are harmonic-shaped.

Terms such as “first”, “second”, and the like, are used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The expression “and/or” should be interpreted to include all possible conjunctive and disjunctive combinations, unless expressly noted otherwise. For example, the expression “A and/or B” should be interpreted to mean only A, only B, or both A and B. The expression “at least one of” should be interpreted in the same manner as “and/or”, unless expressly noted otherwise. For example, the expression “at least one of A and B” should be interpreted to mean only A, only B, or both A and B.

It is to be understood that the features of the various embodiments described herein can be combined with each other, unless specifically noted otherwise.

Although specific embodiments have been illustrated and described herein, it will be appreciated by those of ordinary skill in the art that a variety of alternate and/or equivalent implementations can be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of controlling an electric motor, the method comprising:
storing, in a microcontroller, a first weight matrix calculated to transform an arbitrary set of multi-phase variables of any shape to equivalent quadrature-direct (Q-D) reference frame components, such that the Q-D reference frame components appear as dc signals in steady state, wherein the first weight matrix is a function of a reference frame angle in the Q-D reference frame;
calculating, by the microcontroller, a second weight matrix from the first weight matrix and a constant matrix, wherein the second weight matrix is a function of the reference frame angle; and
commutating winding currents in the electric motor based on the second weight matrix.

2. The method of claim 1, wherein the multi-phase variables are 3-phase variables, and wherein the first weight matrix is calculated from a 2×2 matrix, a 2×3 matrix, and a 3×2 matrix.

3. The method of claim 2, wherein a first column of the 2×2 matrix includes first and second Q-D reference frame values at a first phase shift from a defined angle origin, and wherein a second column of the 2×2 matrix includes the first and second Q-D reference frame values at a second phase shift from the defined angle origin.

4. The method of claim 3, wherein the first phase shift is 0 and the second phase shift is π/2.

5. The method of claim 2, wherein the 2×3 matrix is a constant matrix.

6. The method of claim 2, wherein a first row of the 3×2 matrix includes values of the 3-phase variables at a first phase shift from a defined angle origin, and wherein a second row of the 3×2 matrix includes values of the 3-phase variables at a second phase shift from the defined angle origin.

7. The method of claim 1, further comprising:
programming the first weight matrix stored in the microcontroller for block commutation of the winding currents, trapezoidal commutation of the winding currents, or harmonic injection of harmonic currents into windings of the electric motor.

8. The method of claim 1, wherein calculating the second weight matrix comprises:
calculating each element of the second weight matrix from a quarter wave profile stored in the microcontroller and that defines the shape that the element should follow as a function of the reference frame angle.

9. The method of claim 1, wherein the first weight matrix is calculated to transform a set of multi-phase variables of a block shape to Q-D reference frame dc components, and wherein the elements of the second weight matrix are block-shaped.

10. The method of claim 1, wherein the first weight matrix is calculated to transform a set of multi-phase variables of a trapezoidal shape to Q-D reference frame dc components, and wherein the elements of the second weight matrix are trapezoidal-shaped.

11. The method of claim 1, wherein the first weight matrix is calculated to transform a set of multi-phase variables of a harmonic shape to Q-D reference frame dc components, and wherein the elements of the second weight matrix are harmonic-shaped.

12. A control system for an electric motor, the control system comprising:
a microcontroller configured to:
store a first weight matrix calculated to transform an arbitrary set of multi-phase variables of any shape to equivalent quadrature-direct (Q-D) reference frame components, such that the stationary reference frame components appear as dc in steady state, wherein the first weight matrix is a function of a reference frame angle from the Q-D reference frame; and
calculate a second weight matrix from the first weight matrix and a constant matrix, wherein the second weight matrix is a function of the reference frame angle; and
generate control signals for commutating winding currents in the electric motor, based on the second weight matrix.

13. The control system of claim 12, wherein the multi-phase variables are 3-phase variables, and wherein the first weight matrix is calculated from a 2×2 matrix, a 2×3 matrix, and a 3×2 matrix.

14. The control system of claim 13, wherein a first column of the 2×2 matrix includes first and second Q-D reference frame values at a first phase shift from a defined angle origin, and wherein a second column of the 2×2 matrix includes the first and second Q-D reference frame values at a second phase shift from the defined angle origin.

15. The control system of claim 14, wherein the first phase shift is 0 and the second phase shift is π/2.

16. The control system of claim 13, wherein the 2×3 matrix is a constant matrix.

17. The control system of claim 13, wherein a first row of the 3×2 matrix includes values of the 3-phase variables at a first phase shift from a defined angle origin, and wherein a second row of the 3×2 matrix includes values of the 3-phase variables at a second phase shift from the defined angle origin.

18. The control system of claim 12, wherein the microcontroller is configured to calculate each element of the second weight matrix from a quarter wave profile that is stored in the microcontroller and defines the shape that the element should follow as a function of the reference frame angle.

19. The control system of claim 12, wherein the first weight matrix is calculated to transform a set of multi-phase variables of a block shape to Q-D reference frame dc components, and wherein the elements of the second weight matrix are block-shaped.

20. The control system of claim 12, wherein the first weight matrix is calculated to transform a set of multi-phase variables of a trapezoidal shape to Q-D reference frame dc components, and wherein the elements of the second weight matrix are trapezoidal-shaped.

21. The control system of claim 12, wherein the first weight matrix is calculated to transform a set of multi-phase variables of a harmonic shape to Q-D reference frame dc components, and wherein the elements of the second weight matrix are harmonic-shaped.
